(19) United States
(12) Patent Application Publication
(10) Pub. No.: US 2008/0098237 A1
(43) Pub. Date: Apr. 24, 2008

(54) Secure e-mail services system and methods implementing inversion of security control

(76) Inventors: Trung T. Dung, Alamo, CA (US); Duc N. Pham, Cupertino, CA (US); Tien L. Nguyen, Cupertino, CA (US)

Correspondence Address: GERALD B ROSENBERG;NEW TECH LAW, 260 SHERIDAN AVENUE, SUITE 208, PALO ALTO, CA, 94306-2009, US

(21) Appl. No.: 11/584,153

(22) Filed: Oct. 20, 2006

(51) Int. Cl. H04L 9/32; G06F 17/30; G06F 12/14; G06F 7/04; G06K 9/00; G06F 11/30; H03M 1/68; H04K 1/00; H04L 9/00; H04N 7/16

(52) U.S. Cl. 713/189; 726/27; 726/30

(57) ABSTRACT

A secure e-mail service, executable on a recipient e-mail server or associated computer system, implements inverted security control over recipient content stored by the recipient e-mail server. Recipient content is received in conjunction with e-mail messages transmitted directed to recipients from sender computer systems unassociated with the secure e-mail service. The secure e-mail service includes a policy engine that operates on e-mail messages, as received from a communications network, to evaluate metadata features of the message and select a corresponding encryption key. The service further includes a content processing engine that operates to encrypt a portion of the message in a manner that allows subsequent decryption of said portion using the selected encryption key. A service interface enables transfer of the e-mail message, including the portion as encrypted, to the recipient e-mail server, which supports access by the recipients.

### BACKGROUND OF THE INVENTION

1. Field of the Invention

The present invention is generally related to data security for network transmitted information and, in particular, to systems and methods of securing electronic messages and related content as transmitted between and persistently stored on behalf of users.

2. Description of the Related Art

Information security has and will continue to be one of the most important and, at least as a practical matter, difficult facets of networked computer system management. The widespread distribution and disparate handling of information transmitted between computer systems over communications networks, such as the public Internet and private intranets based on various wired and wireless technologies, introduces many complexities. The immediate transmission and delivery of sensitive information must be secured. The long term storage of the information must also be secured with the specific assurance that the information can be reliably accessed at some later date. The security measures implementing these features, considered from a management reliability perspective, must be unobtrusive to implement, manage, and maintain, both with respect to the computer systems and software involved and the user visible procedures necessary to invoke and use the security controls. A failure at any point results in either a loss of confidence in the ability of the controls to actually establish and maintain security, if not an outright breach of security, or a loss in the ability to recover secured data at some point in the future.

Historically, computer information security systems have largely focused on securing point-to-point transmission of data and, more recently, on establishing source controlled security over the delivered information. For point-to-point security, the concern is to prevent the in-transit snooping of sensitive content. In the case of electronic mail (e-mail) and similar message-based communications systems, content within the message, including content logically attached to a message, is at least theoretically exposed during actual transmission. A greater exposure occurs while the message is resident on a store-and-forward network node. Although presumptively transient, the potential vulnerability to snooping and other security attacks persists.

Transmission security protocols, such as Secure Sockets Layer (SSL) and the subsequently derived Transport Layer Security (TLS) protocols, provide point-to-point encryption security for network communications. Data packets, collectively representing, for example, an e-mail message and attachments, are automatically encrypted at the source and only unencrypted at the destination. Not only is encryption functionally transparent to the source and destination software and systems, the transmitted information remains encrypted even as transiently stored on computer systems within the transmission path. Inclusion of transmission security protocol support in network operating systems is now widespread.

Digital rights management (DRM) systems are characteristic implementations of source managed security over distributed data. In typical implementation, data files are packaged before distribution with the sensitive content encrypted subject to specific certificate-based decryption and use restrictions. A digital rights agent, invoked on a client system requesting access to the content, is required to authenticate the client/user, verify the licensed access rights and establish use controls on the client system. In most instances, use-specific verification of the certificate license is required. Other, somewhat more directly controlled systems, such as shown in U.S. Pat. No. 6,591,367, issued to Korbata et al., rely on a real-time transaction “signal” to qualify use of previously delivered and currently encrypted content on a recipient computer system. Some source controlled security systems, such as shown in U.S. Pat. No. 6,836,846, issued to Kanevsky et al., provide a measure of delegation in evaluating whether a sender defined use restriction is met before allowing access to previously delivered encrypted content. The operation of the digital rights agent, both overall and with respect to a specific DRM secured data file, is enabled and managed by an independent, remote permissions server. This permission server is, in turn, typically controlled by a third-party DRM operator entrusted to manage the DRM security control for many different network distributed data files and licensed users.

While formalized and well established, both transmission security protocols and DRM systems represent incomplete or unacceptable approaches for securing network distributed data for at least certain use scenarios. The transmission security protocols are only applicable to data while in transit. Protocol-driven encryption security is automatically stripped once the data reaches a destination computer system, leaving the data then vulnerable. DRM systems quite clearly project security over information as and after delivery. However, long term access to the DRM permissions server cannot be guaranteed. Specifically, DRM-based systems, as well as the systems described in both Korbata and Kanevsky, inherently allow the sender an unconstrained ability to revoke any and all access by a recipient to prior delivered content. While appropriate in defined circumstances, principally involving conventionally licensed proprietary content, the inability of a recipient to ensure future access to properly received, i.e., fully licensed, content is characteristically unacceptable. Functional access to previously received DRM protected content can also be lost as a result of conventional network and server failures, economic or other failure of the DRM operator, or as a consequence of a security breach of the permissions server related systems.

Other, source controlled security techniques are known and conventionally used to secure distributed content. These systems, with varying degrees of user-directed automation, utilize encryption to protect the distributed content. In the typical application to e-mail systems, the entire body and any accompanying attachments are block encrypted prior to transmission. The recipient is, in turn, required to execute some user-directed operation to identify an appropriate decryption key and then functionally decrypt the received content.

While many different encryption algorithms are available for use, perhaps the most widely used in connection with shared content transmission is public-key encryption. Public-key cryptography is based generation of asymmetric public/private key pairs. A potential recipient, who generates a key pair, maintains the private key secret and publishes the public key for use by potential senders of content to that specific recipient. A recipient may hove, over time if not at the same time, many different published public keys. Content encrypted using a given public key can be decrypted at any time by the recipient using the one corresponding private key. Provided the private key is reliably kept secure, the encrypted content is likewise secure. Decryption without access to the private key, absent a defect in the key generation algorithm, is conventionally considered intractable.

To support public key encryption systems in ordinary use, the public keys are published by recipients to various key servers. Both commercial and general availability key servers are accessible on the Internet. A recipient may generate and publish any number of public keys and arbitrarily withdraw or abandon public keys for various reasons. To securely send content to a recipient, at least one currently active recipient public key must be acquired by the sender. Both the sender and receiver must have installed specific version algorithm compatible cryptography engines, typically as adjuncts to their e-mail client programs. Assuming version compatibility, the recipient must locate the specific private key corresponding to the public key used by a sender in order to decrypt content encrypted by a sender.

As is evident, these user-directed public key and similar security systems impose a significant managerial and operational burdens. Both the sender and recipient users are required to install and maintain mutually compatible encryption software products. Given the potential for use of different typically third-party software products, assured compatibility can be problematic. Furthermore, the users are required to manage and maintain various key-rings storing the user's own key pairs and the public keys of others. While much can be automated, a significant burden remains on the users to direct publication and acquisition of public keys as desired or needed to allow encrypted content-based communications. Moreover, failure by a recipient user to maintain the private key of a key pair results in loss of access to any and all content that remains encrypted with the corresponding public key. This lack of direct key recoverability, while fundamental to security in the first instance, is a practical limitation in the many circumstances where guaranteed access to secured content is a fundamental business or legal requirement. Alternate approaches to key recoverability, principally involving management schemes for collecting, organizing and storing key pairs, create potential opportunities for security breaches and, in any case, further increase the management burden of maintaining and operating working content security systems.

Consequently, a need exists for providing present and future retention of recipient content in a manner that is secure and imposes little operational and managerial burden on both senders and recipients.

### SUMMARY OF THE INVENTION

Thus, a general purpose of the present invention is to provide a system and methods of receiving and storing content in a secure manner with little imposed operational and managerial burden on users and, further, in a manner fully compatible with networked communications systems.

This is achieved in the present invention by providing a secure e-mail service, executable on a recipient e-mail server or associated computer system, that implements inverted security control over recipient content stored by the recipient e-mail server. Recipient content is received in conjunction with e-mail messages transmitted directed to recipients from sender computer systems unassociated with the secure e-mail service. The secure e-mail service includes a policy engine that operates on e-mail messages, as received from a communications network, to evaluate metadata features of the message and select a corresponding encryption key. The service further includes a content processing engine that operates to encrypt a portion of the message in a manner that allows subsequent decryption of said portion using the selected encryption key. A service interface enables transfer of the e-mail message, including the portion as encrypted, to the recipient e-mail server, which supports access by the recipients.

An advantage of the present invention is that content received is maintained securely under the control of the recipient in a manner that assures both current and future access to the content.

Another advantage of the present invention is that implementations do not require modifications of the system or software utilized by senders, including third-party senders. Recipient client systems and software also do not require modification. In the exemplary case of e-mail systems, recipients can obtain access to secured received content from most any local or remote location using a variety of content accessing devices.

A further advantage of the present invention is that system implementation of a secure e-mail service system can be as an external server or as software embedded in an existing server system. Standard networking and system configuration capabilities enable transparent integration of the secure e-mail service, including use of conventional LDAP and Active Directory features.

Still another advantage of the present invention is that system implementations can be configured in a variety of manners, corresponding to desired functionality, including as an embedded service, and external shared or hosted server-based service, as an in-line gateway service, and as an auxiliary service capable of supporting unmodified systems providing, in particular, web mail accounts.

Yet another advantage of the present invention is that system implementations can support utility operations, including content validation to enable spam and virus checks, content encoding conversion including handling of various sender encryption schemes, and to apply any of a set of localized forms of security encryption.

Still another advantage of the present invention is that system implementations can support flexible and selective access delegation, auditing, and secured content recovery capabilities with minimal management requirements essentially transparent to ongoing operation through the use of policy based content handling controls.

### BRIEF DESCRIPTION OF THE DRAWINGS

FIG. 1 is a system block diagram illustrating the architectural implementation of a preferred embodiment of the present invention;

FIG. 2 presents a simplified block diagram of a preferred embodiment of the present invention demonstrating secure interaction by internal and external users;

FIG. 3 is functional flow diagram illustrating multiple potential intercept points where a secure content service can be implemented consistent with different preferred embodiments of the present invention;

FIG. 4 provides a functional flow diagram illustrating a preferred implementation of the present invention supporting Web-based and hosted e-mail accounts;

FIG. 5 is a block diagram showing a preferred implementation of a secure content service as constructed in accordance with a preferred embodiment of the present invention; and

FIG. 6 provides a detailed block diagram of a preferred implementation of a content processing engine system as constructed in accordance with a preferred embodiment of the present invention.

### DETAILED DESCRIPTION OF THE INVENTION

The present invention provides well-defined security control over content, particularly e-mail-based content, for the benefit of recipients and, in preferred implementation, associations or organizations of recipients. In the following detailed description, the invention will be primarily described in terms of preferred e-mail-based embodiments. For convenience, the following terms are defined:

Metadata—control information included as part of the envelope, in the context of an e-mail message, or that part of the content of a message that describes or defines features of the e-mail message including, for example, an addressee, the location of a specified content part of the e-mail message, and the encoding of a specified content part of the e-mail message.

Sender—a user or, in context, a user computer system that originates an e-mail message.

Recipient—a user or, in context, a user computer system that receives an e-mail message.

Addressee—the sender designated recipient identified in the envelope metadata of an e-mail message.

Mail User Agent (MUA)—a program typically executed on a client computer system that provides for the creation and/or retrieval of an e-mail message by a user. Typically implements the conventional Simple Mail Transport Protocol (SMTP) and Post Office Protocol (POP)/Internet Message Access Protocol (IMAP) client protocols.

Mail Submission Agent (MSA)—for the benefit of MUAs that do not implement the SMTP client protocol, a local MSA will operate as an e-mail message receiver providing SMTP client protocol services.

Mail Transfer Agent (MTA)—typically, a server program that implements an SMTP server for receiving e-mail messages from MUAs and MSAs.

Mail Delivery Agent (MDA)—a server program that operates to deliver e-mail messages to local addressee mailboxes, where the e-mail destination is the local e-mail server system, or to relay the e-mail to another MTA along the route towards the destination e-mail server system.

As will be readily apparent to those of ordinary skill in the art, the present invention is equally applicable to other message based communications systems. Therefore, the use of e-mail specific terms in describing the preferred embodiments of the present invention should not be alone interpreted as limiting the scope of the present invention.

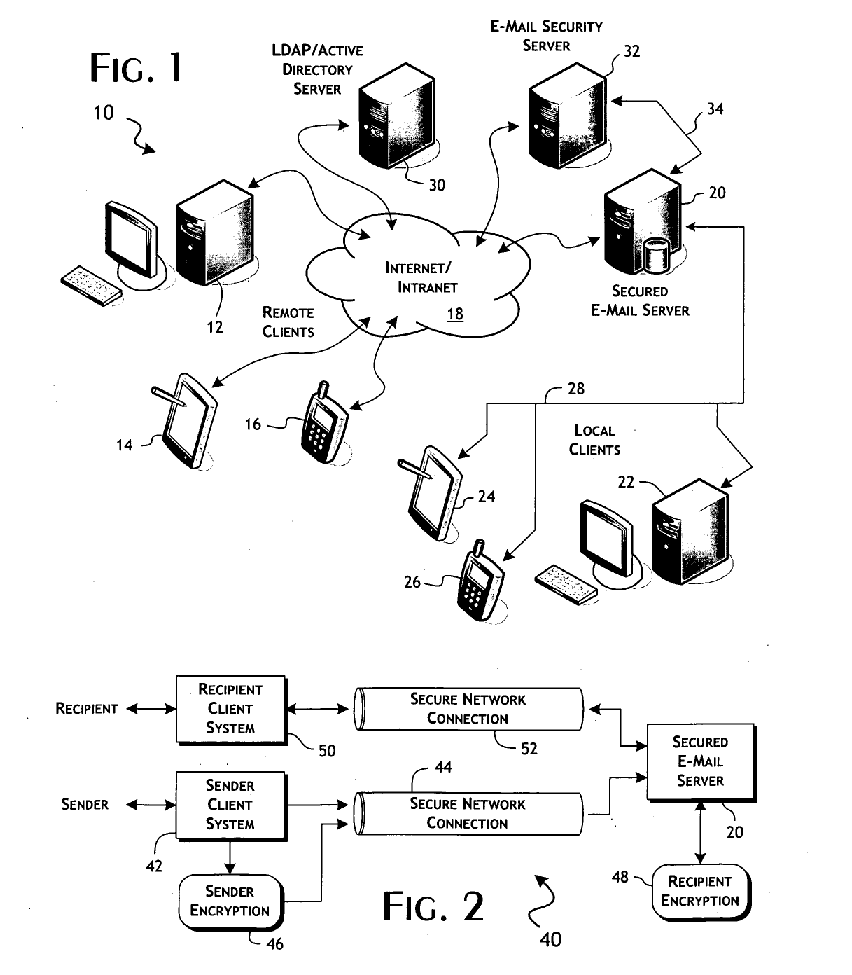

An architecturally representative environment 10 generally suitable for employment of the present invention is shown in FIG. 1. For purposes of discussion, like reference numerals are used to designate like parts depicted in one ore more of the figures. As in conventional e-mail distribution environments, various client computer systems and devices 12, 14, 16 can, through the public Internet, an intranet, or other communications network 18, remotely interoperate with an e-mail server 20 to send and receive e-mail messages. Other client computer systems and devices 22, 24, 26 may also interoperate with the e-mail server 20 through a local, dedicated network connection 28. The e-mail server 20 will typically implement an MTA/MDA system, such as Microsoft® Windows™ Exchange Server 2003 (www.microsoft.com) or Sendmail™, a product available from Sendmail, Inc. (www.sendmail.org). In typical application, the e-mail server 20 is supported by a directory access security server 30, implementing the Lightweight Directory Access Protocol (LDAP), to provide directory services. In relevant part, LDAP is an established Internet standard protocol that provides user and resource authentication services in response to network directed queries.

In a preferred embodiment, the local clients 22, 24, 26 are used by members of an organization that is subject to defined requirements for the long-term secured preservation and reliable access to communications received through the e-mail server 20. The organization may be formal, such as a corporate entity, or informal, representing only a loosely related community of users. The access and preservation controls imposed may be defined by the organization, individual recipient users, or a combination thereof. Organizationally defined requirements may reflect the need to ensure present and future accessibility to organization owned information and to securely control accessibility to information that the organization becomes responsible for protecting. In particular, the organization may be obligated under legal and contractual requirements to enable independent auditing and to meet the compliance requirements of public laws, such as the Sarbanes-Oxley Act of 2002, and court orders for the production of documents. The remote devices 12, 14, 16 may be owned or operated by information senders that are independent or outside of the organization or they may be organization members who are remotely accessing the e-mail server 20.

In a preferred embodiment, an e-mail security service server 32 is provided to implement an e-mail security service to establish security control over information provided by senders to some one or more members of the organization served by the e-mail server 20. The information is provided as recipient content associated, integrally or by attachment, to an e-mail message transmitted by a sender to a recipient identified as a member of the organization served by the e-mail server 20. The e-mail security service may be implemented on a server computer system, such as the server 30, separate from the e-mail server 20 with communication routed through the Internet or intranet 18 or through a local, secure communications network 34. The e-mail security service may also be implemented on the e-mail server 20, or on a relaying MTA/MDA server, as a service program executed in conjunction with the existing resident MTA/MDA program.

In accordance with the present invention, the e-mail security service, whether implemented on the server 32 or as a service program executed on another e-mail server 20, operates to implement an inversion of security control over recipient content directed to the associated e-mail server 20. Inversion of security control is obtained by securing recipient content, typically by encryption, in a manner determined internally by the organization for the benefit of the organization members. Security over the recipient content is thereby established effectively independent of the senders of the content. That is, as implemented in the preferred embodiments, any security measures provided or applied by or on behalf of the senders are removed from the recipient content on receipt and the recipient content is then secured persistently in a manner determined appropriate by the recipient organization.

As generally shown in FIG. 2, a system 40 implementing inversion of security control over recipient content provides for any sender, operating from a remote or otherwise external client system 42, to send an e-mail message directed to a recipient user of the e-mail server 20. Where a security concern exists for the recipient content sent by e-mail, the sender can ensure transmission security by specifying use of a secure network connection 44. Conventional MUAs support specification of a connection using the SSL or TLS protocol for transport transmission of messages and attachments. The sender may further apply sender encryption 46 to the recipient content to protect the information on the client 42 pending transmission and, at least by intension, on the e-mail server 20 after receipt. Various encryption protocol systems, such as Secure Multipurpose Internet Mail Extensions (S/MIME), now maintained by the Internet Engineering Task Force (IETF), and Pretty Good Privacy (PGP; www.pgp.com), can be specified by senders for this purpose.

On receipt of an e-mail message, the e-mail server 20 will automatically remove the security protections provided by the SSL/TLS protocol. To implement inversion of security control, in accordance with the present invention, any applied sender encryption 46 is also automatically removed by operation of the e-mail security service executed by or on behalf of the secured e-mail server 20. The e-mail security service determines, preferably based on policies determined and established by the organization for the benefit of recipients, whether to encrypt 48 recipient content within the e-mail message and, further, the encryption key or keys that will enable corresponding decryption. The recipient encrypted e-mail message is then stored by the e-mail server 20 for access by the recipient users. The e-mail security service thereby takes responsibility for the immediate and long-term security of recipient content as persistently stored on the e-mail server 20 for the benefit of the recipient users of the organization.

Recipient users access the e-mail server 20 using recipient client systems 50, which may be local or remote MUA clients of the e-mail server 20. The encryption 48 of the recipient content is preferably encoded into the stored e-mail messages S/MIME in order to be compatible with the operation of conventional MUAs. Retrieved e-mail messages are thereby secured as retrieved by the MUAs, with decryption performed on the client 50 as the content is presented to the recipient user. Use of a secure network connection 52 for the retrieval of e-mail messages is not required, but is preferred if only to protect otherwise unencrypted e-mail messages or unencrypted e-mail portions during transport.

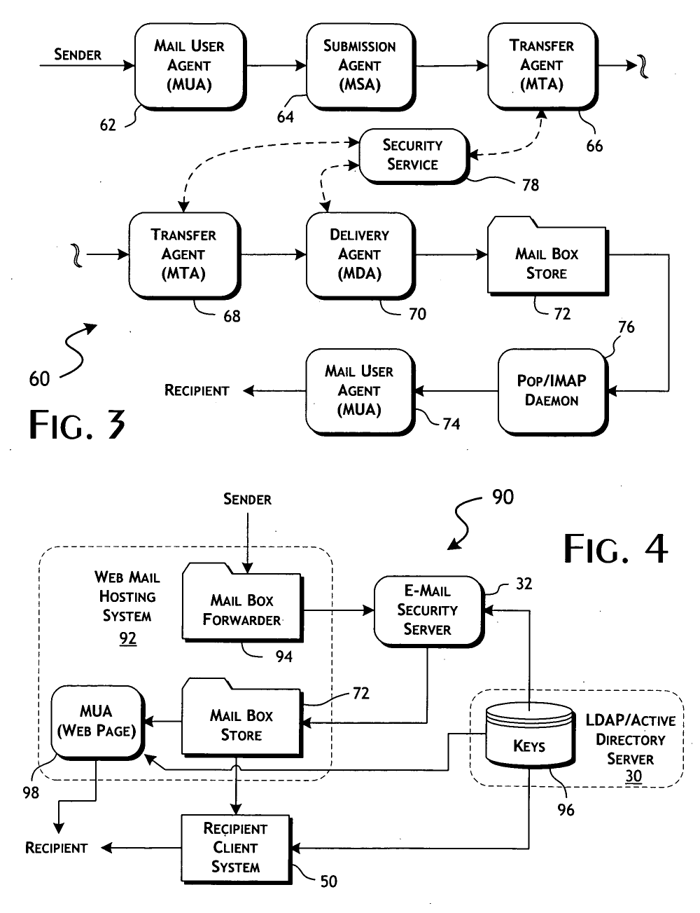

The present invention is preferably implemented relative to a logical boundary, defining a protected realm, for an organization or association of recipients. The e-mail security service of the present invention can, however, be flexibly architected for use as a gateway, router, or proxy service to suit many different operating scenarios. As generally shown in FIG. 3, an e-mail message, sent by a sender using a MUA client 62 through a MSA 64, will travel through some number of MTAs 66, 68, before reaching a MDA 70 capable of delivering the e-mail to an appropriate mailbox within a mailbox store 72. As is conventional, the mailbox can be accessed by a recipient using a client MUA 74 through the services provided by a POP/IMAP daemon 76. The e-mail security service 78 can operate, in accordance with the present invention, as a gateway server that implements or at least appears to be an MTA in the chain of MTAs 66, 68. As a router, a gateway server can route e-mail messages through the e-mail security service 78 implemented on a router or server logically internal to the protected realm that again preferably appears to be an MTA in the chain of MTAs 66, 68. Alternately, an MDA 70 can employ the e-mail security service 78 as a back-end or proxy service. To utilize the e-mail security service 78 as a proxy service, the MDA 70 internally operates to route received e-mail messages through the e-mail security service 78. The presently preferred embodiment is implemented as a plugin service installed on an MTA 66, 68. In the specific implementation of a Sendmail MTA, the plugin service is supported through the Sendmail Content Management API (Milter).

Referring to FIG. 4, a preferred proxy implementation 90 of the e-mail security service suitable for supporting Web mail MDAs 70 is shown. E-mail messages from senders are received by the MDA 70 of a conventional Web mail hosting service 92 directed to a public mailbox 94 of an intended recipient. Preferably, the public mailbox 94 is configured to forward received e-mail messages to an e-mail security server 32 typically established external to the Web mail hosting service 92. The e-mail security service 78 implemented by the e-mail security server 32 accesses necessary authentication information and encryption keys provisioned on the directory access security server 30, also preferably established external to the Web mail hosting service 92. E-mail messages can thereby be autonomously processed through and secured by operation of the e-mail security server 32.

E-mail messages processed by the e-mail security server 32 are then returned to an internal or private mailbox also located within the mailbox store 72 of the Web mail hosting system 92. This private mailbox is simply a standard e-mail mailbox having an e-mail address different from that of the public mailbox of the recipient. The typically Web page-based MUA 98 provided by the Web mail hosting system 92 and any client MUA 74, as executed on a client computer system 50, access the private mailbox to read received e-mail messages. Both the Web page-based MUA 98 and client MUA 74 have access to the directory access security server 30 to retrieve encryption keys necessary for reading the content protected by operation of the e-mail security service 78. E-mail messages sent using the private e-mail mailbox are, in conventional manner, preferably sent with the appearance of originating from the public mailbox account.

Alternative configurations of the proxy implementation 90 include functionally combining the public and private mailboxes of a recipient. In this case, the forwarding operation of the public mailbox 94 is set to not forward messages received from the e-mail security server 32. In another configuration, the Web mail hosting system 92 may be operated only as a generic front-end to an existing e-mail system of an organization or association of recipients. In this case, the mailbox store 72 can be implemented external to the Web mail hosting system 92.

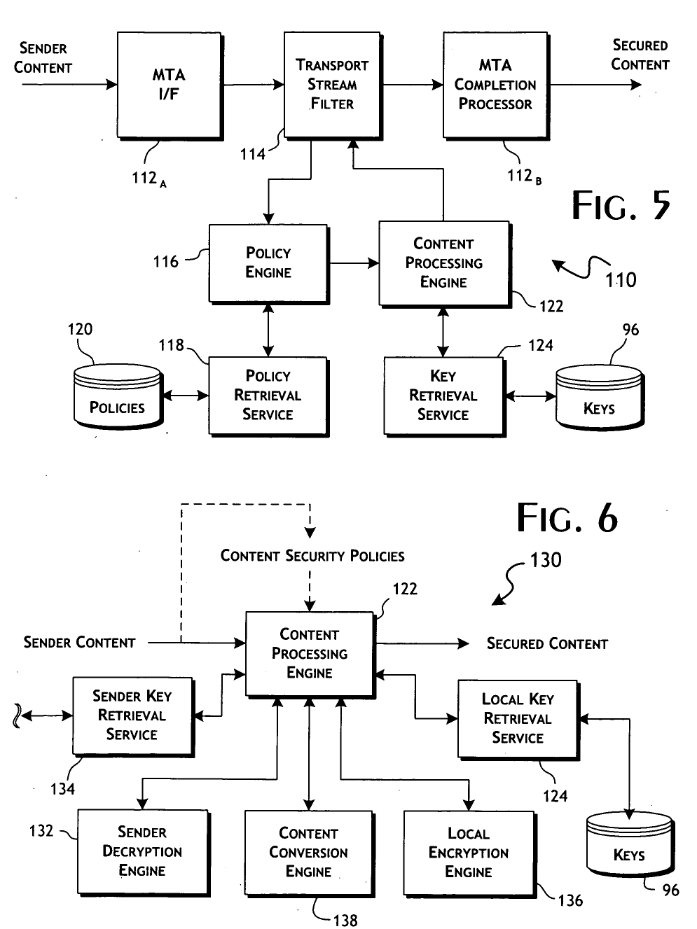

A preferred implementation of the present invention as a filter 110 within an MTA 112 is shown in FIG. 5. Sender e-mail messages are sequentially received through a front-end interface 112A of the MTA 112 and transferred through the filters installed or otherwise registered with the MTA 112. In particular, a transport stream filter 114 consistent with the present invention is provided to intercept e-mail messages. The e-mail messages are routed through policy engine 11 6 for analysis, principally involving an examination of the e-mail metadata fields. These metadata fields contain values that will, in defined structured forms, identify the sender and intended recipient or recipients of the e-mail and the location and encoding of potentially multiple content portions of the e-mail message, including attachments. While most metadata fields will be present as part of the e-mail envelope, others may be embedded within the e-mail message.

The policy engine 116 is preferably structured as a rule-based pattern matching engine utilizing a tree-based decision structure to provide flexibility in the design and application of rules. Individual rules may be specified, for example, as applying to one or more particular metadata fields potentially further defined by name, type or location (as part of a message envelope or embedded in the body), to a word or phrase found in the body of an e-mail message or in any one or more metadata fields, to any attachment, or to the entirety of an e-mail message, including attachments. A regular-expression notation is preferably supported to define content matchable by a rule. Thus, by operation of the policy engine 116, the e-mail message can be characterized by sender/recipient relations, on the basis of included content and on keywords and phrases included within the e-mail message. In alternate embodiments of the present invention, the rule-based pattern matching engine may be replaced or augmented by a Bayesian-inference engine to enhance the ability to characterize the content of e-mail messages processed through the policy engine 116.

For the presently preferred embodiments, policy rules are organized in pre-policy, user policy, and post-policy rule groups. This organization allows flexibility in tailoring global and user specific rule sets. Each rule group consists of zero or more rules. When an e-mail message is received, the recipient e-mail address is used to identify the recipient's, or user's, profile including policies to be applied to the message. Multiple rule sets of the same group type may be applied per message per user. That is, within a rule group type, rule sets are preferably organized in a hierarchical structure. For example, a domain hosting service might define a System, Host hierarchy where the System pre-policy is applied first, followed by the Host pre-policy, the user policy, the Host post-policy, and System post-policy.

Each rule consists of Conditions and Actions. Multiple actions can be specified in a single rule. Evaluation of rule conditions follow:

```
  a) If the evaluation result of a given Condition is TRUE, the associated
action(s) is(are) carried out. Unless a ”continue” action is specified to
tell the policy engine to continue with the next rule, the current policy
processing rule is completed.
  b) Else, the next rule in the current group is processed until all rules
in the current group are processed.
  c) Else, the first rule in the next group is processed.
    Each condition is a statement of the form:
  <operand1> [NOT] <operator> <operand2>
    in which:
  <operand1>={From, To, Subject, Body, Sensitivity, Attachment, . . . }
    a) These are named e-mail metadata fields or other defined
      structures present as envelope fields or fields embedded
      within the body of a message
  [NOT]= inverted logic operator; brackets indicate optional use
  <operator>={Contains, Starts With, Ends With, Equals, RegEx,
    ISENCRYPTED}
    a) Contains, Starts With, Ends With, Equals are string match
      operators. RegEx is a regular expression operator
    b) ISENCRYPTED has no operand. It returns a TRUE if the policy
      processing so far resulted in an encrypted message. Else, it
      returns a FALSE.
  <operand2>= ”string match pattern”
    a) All string operations are non-case sensitive. Multiple conditions
      in a rule are ANDed together to create a single TRUE or
      FALSE condition result.
    Each action is a statement of the form:
  <operator> <operand1> <operand2>
      in which
  <operator>={Encrypt, Prefix, Suffix, Change, Forward, CONTINUE,
    SETVAR, DELVAR}
    a) CONTINUE: policy processing is to be continued with the next
      rule.
    b) SETVAR <varName> <varValue>: Set (create if it does not exist)
      variable <varName> with the value <varValue>. The
      variable only exists for the currently processed message, and
      the scope is for the entire message. Therefore, a variable set
      by a pre-policy could be used by anything after the SETVAR
      statement, which includes the subsequent pre-policy
      statement, the user's policy, and the post-policy.
    c) DELVAR <varName>: Delete the variable <varName>.
  <operand1>, <operand2>: depending on the action, there might be one
    or more operands used to specify the effect of the operation.
```

For example, to implement a basic configuration for selective security protection, a recipient may specify a first e-mail address for receipt of ordinary content, such as personal, non-business, and a second e-mail address for sensitive content. While the two e-mail addresses may and preferably are aliased to the same mailbox by the MDA 70, the policy engine 116 operating at the level of an MTA 66, 68 in the path of both e-mail addresses recognizes the distinction in the “To” metadata fields, passes through e-mail directed to the first address and substantively processes e-mail directed to the second address. Alternately, the policy engine may be established only in the routed path of the second address.

To selectively secure sensitive e-mail received through a Web or other third-party e-mail hosting system, the forwarding agent of the hosting system should be set to forward received e-mail messages to an e-mail address routed through an e-mail security server 32. The forwarding agent should also be configured to delete any local copy of the e-mail forwarded. Finally, the forwarding agent should be set to accept without forwarding e-mail received from the e-mail security server 32. The policy rules implemented on the e-mail security service 78 of the e-mail security server 32 will determine whether specific e-mail instances are secured.

To selectively secure an entire e-mail domain, or security realm, the domain name service (DNS) mail exchanger (MX) record is preferably set to point to the e-mail security server 32. Consequently, all e-mail messages to the protected realm route through the e-mail security server 32 and are subject to policy processing.

A simplified example of a rule set is provided in Table 1:

TABLE 1

| Rule Condition | | | | |
|---|---|---|---|---|
| Rule | Field | Operator | Text | Rule Action(s) |
| 1 | subject | contains | Acquisition | Change [Subject] to |
| | | | | “Discussion” |
| | | | | Add [Cc] Proj83 group |
| | | | | Encrypt [Body] with |
| | | | | “_myKey” |
| | | | | Encrypt [Attachment] |
| | | | | with “_myKey” |
| | | | | Encrypt [Body] with |
| | | | | “_proj83” |
| | | | | Encrypt [Attachment] with |
| | | | | “_proj83” |
| 2 | subject | contains | BOD | Encrypt [Body] with |
| | | | | “_myKey” |
| | | | | Encrypt [Body] with |
| | | | | “_audit01” |
| 3 | from | contains | myCorp.com | Encrypt [Body] with |
| | | | | “_myKey” |
| 4 | | | | Encrypt [Body] with |
| | | | | “_myKey” |
| | | | | Encrypt [Body] with |
| | | | | “admin32” |

Where:
Rule 1 specifies that if the e-mail subject field contains the word “Acquisition”, then change it to “Discussion”, and encrypt both the body of the message and any attachments using keys identified by “_myKey” and “_proj83”. The e-mail is also copied to the members of a defined “Proj83” e-mail group. In typical implementation, the “_myKey” key is associateduniquely with the e-mail recipient while the “_proj83” key is added to allow content access by the members of the corresponding project group.
Rule 2: specifies that if the e-mail subject field contains the word “BOD”, encrypt the body using a key identified by “_myKey”. The word “BOD” is used for all emails that are related to the Board of Directors. Rule 2 also allows the e-mail to be independently accessible by the members of a corporate audit group having access authority to the key designated “audit01”.
Rule 3: all emails coming from the domain myCorp.com are encrypted exclusively using a key identified by “_myKey”.
Rule 4: for all other emails, encrypt the body using keys identified by “_myKey” and “admin32”. Rule 4 thus demonstrates access delegation by enabling a designated support staff administrator, or group of administrators, authorized to use the “admin32” key to access this e-mail content even where they are not a recipient.

Policy rules are retrieved through a policy retrieval service 118 from a persistent policy store 120 on initialization of the policy engine 116. Preferably, rules are retrieved, on demand, from the store 120 dependent on the progression of rule evaluation required by the policy engine 116. In typical implementation, policy rules are cached in memory for subsequent use.

The policy engine evaluation of rules applicable to a particular message define the policy actions to be implemented by a content processing engine 122. These actions, presented as actionable policy statements, are presented to the content processing engine 122 concurrent with the e-mail message, including attached content. Consistent with the preferred rule definitions provided above, the actionable policy statements are used by the content processing engine 122 to determine rewriting of the e-mail message metadata, including addition of e-mail metadata fields arid values, encryption of different selected content portions of the e-mail message, including attachments, and the selection of the keys that will be permitted to enable decryption of the different encrypted content portions of the e-mail message. Thus, for example, a policy statement can direct existing recipient names be rewritten, singularly or in combination, to add or complete the content of other metadata fields, such as add additional “bcc” recipient names. Other policy statements can specify that discrete portions of the body be encrypted and corresponding S/MIME, or equivalent, metodata fields be added to the body respectively referencing the encrypted portions. Additional policy statements can specify, for each encrypted portion, one or more encryption keys to be associated with that portion to authenticate the decryption of that encrypted portion of the e-mail message. The content processing engine 122 operates to functionally implement these policy statements operating on the data stream representing the e-mail message, including attachments. Encryption keys referenced by the policy statements are obtained through a key retrieval service 124 from a persistent, secure key store 96. For the preferred embodiments of the present invention, the key retrieval service 124 and persistent store 96 are implemented by the directory access security server 30.

The e-mail message, as modified by the content processing engine 122, is returned to the transport stream filter 114 to complete processing through the MTA completion stage 112B of the MTA 112. In accordance with the present invention, at least the minimum required envelope metadata fields remain presented in conventional form. Thus, the operation of the present invention is essentially transparent to the normal function of the MTA 112, other MTAs 66, 68, MDA 70, and client MUAs 74.

In accordance with the present invention, the content processing engine 122 preferably provides for the removal of persistent security controls applied by or on behalf of the sender. Initial removal of source applied encryption is desired to enable conversion to recipient controlled security, i.e., inverted security control, and to allow selected clear text possessing of the received content. Removal of Source encrypted content can be skipped where the source applied encryption is effectively determined by the recipient, such as through requiring senders to use only a recipient specified encryption key and algorithm, no additional encryption keys need be added on receipt (or can be added to the envelope set of encryption keys with re-encryption), and no clear text processing of the content is required.

Source encryption applied by use of an SSL/TLS protocol for transmission will be removed automatically by the server system hosting the security service of the present invention. PGP-based or other sender encryption will remain, though properly identified by an S/MIME or equivalent metadata field associated with the encrypted block of content. As shown in FIG. 6, a sender decryption engine 132 is preferably provided as an adjunct to the content processing engine 122. The sender decryption engine 132 preferably implements a full complement of the S/MIME compatible decryption algorithms and other and other de-facto standard decryption algorithms, such as PGP.

A sender key retrieval service 134 is preferably provided to support operation of the content processing engine 122. In typical implementation, the sender key retrieval service 134 obtains, from a local secure key store or remote directory access security server 30, the private keys needed by the sender decryption engine 132 to decrypt the secured content of received e-mail messages. For encrypted content parts marked by a S/MIME metadata field, the content processing engine 122 preferably directly identifies and directs key retrieval and decryption. Where a content part is not identified explicitly by a standard metadata field, the content processing engine 122 can operate to identify the encryption algorithm from, for example, characteristics of the encrypted content part, such as embedded headers and the attachment filename suffix. If not directly determinable from the associated metadata field, the likely identity of the public encryption key can be determined from analysis, for example, of the sender, recipient, subject, and other metadata fields, and characterization of the unencrypted body text. Once identified, the corresponding private encryption key can then be retrieved for use by the sender decryption engine 132.

The processing of clear text content is preferably performed by a content conversion engine 138 under the control of the content processing engine 122. In typical implementation, the content conversion engine 138 can implement a filter interface, allowing hosting of other existing filters of defined function requiring content access, such as conventional filters for unsolicited bulk e-mail (UBE) and unsolicited commercial e-mail (UCE), both colloquially referred to as spam, and virus detection filters. These hosted filters can operate to characterize the body of an e-mail message, such as through the addition of a spam rating header, or to modify the message, such as by removal of viral code and attachments.

The content conversion engine 138 can also perform formatting and translating conversions of content from one identified form to another. For example, a policy rule, realized as an actionable policy statement, may specify that certain content types, such as images, embedded in the body of a message are to be converted into external attachments. In such a case, the content conversion engine 1 38 operates to reformat the e-mail message to present images as external attachments. Other policy rules may be used to specify content-type identified blocks of content be converted to a different given type. The present invention recognizes that the many existing proprietary data formats, though common in the short term, may not be reliably accessible over the long term. In many cases, a reasonably equivalent file format is known and may be perceived by a recipient or organization as more likely to be accessible well into the future. In response to an actionable policy statement, a content block of defined content type is converted by the content conversion engine 138 to a given survivor content type. Thus, for example, graphics formats considered likely to become marginal, if not orphaned, are by policy converted automatically into a perceived survivor format, such as JPEG or PDF. Document formats can also be converted to a chosen survivor document or image format. Even where format obsolescence is not a concern, an established policy of, for example, converging related formats to a single archival standard for an organization can be supported by the content conversion engine 138.

Once sender applied encryption is removed and applicable content conversions are applied, the content processing engine 122 utilizes a local encryption engine 136 to re-encrypt selected content portions of the e-mail message and attachments. The portions selected typically include those that were subject to sender applied encryption. In accordance with the present invention, however, the final selection of content portions that will be subject to locally applied encryption is determined by the policy engine 116. That is, that a content portion is subject to sender applied encryption can be recognized, by rule, and functionally considered in conjunction with, for example, the sender and recipient names and the characterization of the content in determining whether local encryption is to be applied.

Thus, a system and methods for implementing an inversion of security control over recipient content has been described. While the present invention has been described particularly with reference to e-mail message-based systems, the present invention is particularly applicable to other messaging systems, including Internet messaging (IM) systems, message based content distribution systems, and voice over IP (VOIP) systems.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A secure e-mail service, executable on a designated computer system having a defined association with a recipient e-mail server, implementing inverted security control over recipient content as persistently stored within a repository maintained on behalf of a recipient by said recipient e-mail server, said recipient content being provided in association with a message transmitted over a communications network from a sender computer system unassociated with said designated computer system directed to said recipient, said recipient content being accessible by said recipient from said repository, said secure e-mail service comprising:
a) a policy engine responsive to an e-mail message received from a communications network, said policy engine being operative to evaluate said e-mail message and provide for selection of a corresponding encryption key;
b) a content processing engine, coupled to said policy engine, operative to encrypt a portion of said e-mail message, the encryption of said portion of said e-mail message performed to permit subsequent decryption of said portion using said corresponding encryption key; and
c) an interface, coupled to said content processing engine, operative to provide said e-mail message, including said portion as encrypted, to said repository.

2. The secure e-mail service of claim 1 wherein said policy engine is operative to provide for the selection of a set of corresponding encryption keys and wherein said content processing engine provides of the encryption of said portion that enables subsequent decryption of said portion using any of said set of corresponding encryption keys.

3. The secure e-mail service of claim 2 wherein said policy engine is operative to recognize a set of metadata features present within said message, said policy engine including a rule-base of policies, said policy engine being operative to evaluate said set of metadata features against said rule-base to provide for selection of said set of corresponding encryption keys.

4. The secure e-mail service of claim 3 wherein said metadata features include message data fields present within said message, wherein evaluation of said set of metadata features includes value-based evaluation of said message data fields against said rule-base.

5. A method of securing content electronically transmitted as part of a message passed between computer systems from a sender directed to a recipient, wherein the content is persistently stored for the benefit of the recipient subject to security constraints defined on behalf of the recipient, said method comprising the steps of:
a) receiving an electronic message, including a content instance, directed to a first recipient user;
b) parsing said electronic message to recognize a metadata feature associated with said content instance;
c) encrypting said content subject to a constraint that an encryption key associated with a second recipient user identified by defined relation to said metadata feature will enable decryption of said content; and
d) providing access to said message to said first and second recipient users.

6. The method of claim 5 wherein said first and second recipient users are the same recipient user.

7. The method of claim 5 wherein said constraint provides for any of multiple encryption keys identified by defined relation to said metadata feature to enable decryption of said content.

8. The method of claim 7 wherein said step of parsing recognizes first and second sets of metadata features, wherein said first recipient user is identified by defined relation to said first set of metadata features and said second recipient user is identified by defined relation to a second set of metadata features.

9. The method of claim 8 wherein said multiple encryption keys include encryption keys identified with said first and second recipient users.

10. The method of claim 5 wherein said step of parsing recognizes a plurality of metadata features, wherein said electronic message includes a subset of said plurality of metadata features, said method further comprising the step of resolving said subset against a rule-base to identify said encryption key.

11. The method of claim 10 wherein said first and second recipient users are the same recipient user.

12. The method of claim 10 wherein said step of resolving identifies a plurality of encryption keys and wherein said constraint provides for any of said plurality of encryption keys to enable decryption of said content.

13. The method of claim 12 wherein said step of receiving provides for the removal of security measures applied to said message.

14. An e-mail security service, interoperable with an e-mail server, implementing inverted security control over e-mail content directed to said e-mail server, said e-mail security service comprising:
a) a first interface coupleable to an e-mail transmission path between a sending computer system and said e-mail server, said first interface being operable to intercept an e-mail message directed to said e-mail server on behalf of at least one of said recipient users;
b) a security service engine, coupled to said first interface, operative to evaluate said e-mail message to recognize a metadata feature of said e-mail message, said security service engine being further operable to select an encryption key dependent on a value of said metadata feature and selectively encrypt a portion of said e-mail message subject to decryption using said encryption key; and
c) a second interface coupled to said security service engine and coupleable to said e-mail transmission path, said second interface being operable to transfer said e-mail message, as processed by said security service engine, to said e-mail server.

15. The e-mail security service of claim 14 wherein said security service engine is operative to recognize a plurality of metadata features of said e-mail message, wherein said security service engine includes a predefined set of policies, said security service engine being operative to evaluate said plurality of metadata features against said predefined set of policies to determine said encryption key.

16. The e-mail security service of claim 15 wherein said security service engine, response to the evaluation of said plurality of metadata features, is operative to identify a plurality of encryption keys and to encrypt said portion of said e-mail message subject to decryption by any one of said plurality of encryption keys.

17. The e-mail security service of claim 16 wherein said first and second interfaces are coupled between a mail transfer agent and a mail delivery agent.

18. The e-mail security service of claim 16 wherein said first and second interfaces are coupled between first and second mail transfer agents.

19. The e-mail security service of claim 16 wherein said first and second interfaces are coupled to predefined filter interfaces within a mail delivery agent.

20. An e-mail security service, interoperable with an e-mail server, implementing inverted security control over e-mail content directed to said e-mail server, said e-mail security service comprising:
a) a first interface coupleable to an e-mail transmission path between a sending computer system and said e-mail server, said first interface being operable to intercept an e-mail message directed to said e-mail server on behalf of at least one of said recipient users;
b) a security service engine, coupled to said first interface, operative to evaluate said e-mail message to recognize a metadata feature of said e-mail message, said security service engine being further operable to select an encryption key dependent on a value of said metadata feature and selectively encrypt a portion of said e-mail message subject to decryption using said encryption key; and
c) a second interface coupled to said security service engine and coupleable to said e-mail transmission path, said second interface being operable to transfer said e-mail message, as processed by said security service engine, to said e-mail server.

21. The e-mail security service of claim 20 wherein said security service engine includes a set of policies, wherein said security service engine is operable to evaluate said set of policies relative to said metadata feature to define the selective encryption of said portion of said e-mail message.

22. The e-mail security service of claim 21 wherein said security service engine is operable to selective encrypt said portion subject to decryption using a plurality of encryption keys determined from evaluation of said set of policies.

23. The e-mail security service of claim 22 wherein said security service engine is further operable to autonomously decrypt said portion of said e-mail message to remove a source applied security control applied by said sending computer system.

24. The e-mail security service of claim 23 wherein said security service engine is further operable to process said portion of said e-mail message and selectively modify said e-mail message.

25. A method, executed on a computer system, of establishing an inversion of security control over content received from senders and persistently held for the benefit of recipients, said method comprising the steps of:
a) receiving, through a communications network, an electronic message originated by a sending user, wherein the content of said electronic message is secured by a source security control specified by said sending user;
b) autonomously removing said source security control from said electronic message as received;
c) autonomously applying a recipient security control to said electronic message to secure the content of said electronic message wherein selection of the applied said recipient security control is determined from a policy defined relative to a recipient and unspecified by said sending user; and
d) storing said electronic message subject to said recipient security control subject to access by said recipient.

26. The method of claim 25 wherein said electronic message includes a plurality of metadata fields and wherein said step of autonomously applying includes parsing a plurality of policy rules against said plurality of metadata fields to select said policy.

27. The method of claim 26 wherein said policy provides for the selection of a plurality of recipient security controls to said electronic message.

28. The method of claim 15 further comprising the step of processing the content of said electronic message to provide for the selective modification of the content of said electronic message, said processing step being performed between said steps of autonomously removing and autonomously applying.

29. The method of claim 28 wherein said step of processing includes identifying the content of said electronic message as including spam.

30. The method of claim 28 wherein said step of processing includes identifying the content of said electronic message as including a virus.

31. The method of claim 28 wherein said step of processing includes conversion of the content of said electronic message.
